(19) United States
(12) Patent Application Publication
(10) Pub. No.: US 2011/0218839 A1
(43) Pub. Date: Sep. 8, 2011

(54) Methods and systems for enabling the purchase of deliverable goods & services

(76) Inventor: Ravi Vijay Shamaiengar, Willamsburg, VA (US)

(21) Appl. No.: 12/288,647

(22) Filed: Oct. 22, 2008

Related U.S. Application Data
(60) Provisional application No. 60/999,899, filed on Oct. 22, 2007.

(51) Int. Cl. G06Q 30/00; G06Q 10/00

(52) U.S. Cl. 705/7.32; 705/27.1; 705/14.53

(57) ABSTRACT

Exemplary embodiments of the interactive shopping module provide shopping tools that may include a consumer goods and/or services media channel, a shopping services module for interaction via a display device of a consumer's media device (also referred to as a “communications device”), consumer profile data, advertising data, desirable consumer characteristics and metrics, and detailed vendor and catalog data such as hours of operation, delivery times, historical consumer satisfaction data, pricing data, food ingredient(s), allergy warning(s), and nutritional data, graphical images of menu items, and/or menu descriptions. Some of the embodiments may include shopping services for take-out and/or delivery food, entertainment, apparel, gifts, and/or household merchandise. In other exemplary embodiments, the consumer, vendor, and/or communications provider may match a range of discounted pricing data to identify a discounted price point to maximize sales to a plurality of consumers. According to further exemplary embodiments, billing systems and methods include invoicing, processing, and/or payment of the order from the vendor to the communications provider.

### CROSS REFERENCE TO RELATED APPLICATION

This application claims the benefit of co-pending U.S. Provisional Application No. 60/999,899 filed on Oct. 22, 2007, and of which is incorporated herein by reference in its entirety.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND

This invention generally relates to data processing and, more particularly, to electronic acquisition, distribution, billing, and tracking of consumer goods and services, such as, for example providing means for an electronic dining and delivery service of take-out food to a customer via an interface among a customer's media device, a third party media provider, and/or a take-out delivery provider. Moreover, this invention may access customer and interactive viewership/communication information in order to provide selected marketing information to the customer's communications device.

Conventional systems and methods lack simple, effective, and efficient means for selection of and processing information associated with consumer goods and services, for associating customer characteristics, for determining viewer (i.e., customer) characteristics, and for conveniently billing customers. Conventional systems and methods also lack simple and efficient means for providing desirable user information or tracking customer patterns or preferences. There is, accordingly, a need in the art for easy-to-use communications and/or procurement tools of consumer goods and services.

### SUMMARY

The aforementioned problems, and other problems, are reduced, according to exemplary embodiments, by methods, systems, computer programs, and computer program products providing interactive shopping tools (also referred to herein as “uSurfnShop”) that may include a consumer goods and services media channel or other communications medium, a shopping services module for user-interaction via a display device or an interactive voice recognition device associated with a customer's media device, customer profile data, advertising data, desirable customer characteristics and metrics, detailed vendor and menu data such as hours of operation, delivery times, historical order data including historical customer satisfaction data, pricing data, food ingredient(s), allergy warning(s), and nutritional data, graphical images of menu items, menu descriptions and combinations thereof. Some of the embodiments may include shopping services for take-out food, entertainment, apparel, gifts, and/or household merchandise. In general, the exemplary embodiments target methods and systems for enabling the purchase of deliverable goods and services via a remote, electronic ordering system.

According to an exemplary embodiment, the shopping tool comprises an interactive dining and delivery tool that receives near real-time data from a customer regarding the selection of menu items and use of data content to process a take-out order and/or to otherwise provide access and information about the take-out order. For example, in an exemplary embodiment, the dining and delivery tool enables the customer to track his/her order to find out information related to whether the order is being prepared, is in transit, a location and route of the ordered takeout food, and/or historical information about the take-out order (e.g., billing information, contents of take-out order, delivery address, a rating associated with the take-out order, etc.). Further, some of the embodiments include additional presentation capabilities so that a customer can access nutritional information associated with a menu item, access collective nutritional information about a take-out order, and/or filter or provide an alert on menu items that contain ingredients that a customer may need to or want to avoid (e.g., allergic to an ingredient, another medical reason for not eating, a religious reason for not eating, a personal preference for not eating (e.g., vegetarian), etc.).

According to other exemplary embodiment, the interactive shopping tool may include receiving an interactive shopping directory that includes one or more directory listings of vendors that provide a good and/or a service. The interactive shopping directory allows a user (also referred to herein as a “consumer” or “customer”) to access, select, and/or place an order. Moreover, the interactive shopping directory might include communications broadcast channels that provide interactive shopping tools for an identification category of a good and/or a service offered by the vendor (e.g., a channel for automotive goods and services, a food channel, a legal channel for ordering law services, a beauty channel, and others). In addition, the directory listing includes further information about the vendor such as a vendor communications address (e.g., telecommunications address, electronic communications address, etc.), a physical address of the vendor, billing information for paying the vendor, historical information associated with the vendor such as historical pricing discounts and specials, warranty data, and/or customer satisfaction survey data. The interactive shopping directory may be stored to a media device such as a set top box, a cellular phone, an interactive television, and/or other media devices for presentation to a display for a user to interact with the shopping tool. Other exemplary embodiments include receiving a search parameter for searching the interactive shopping directory to select and order from a vendor. In addition, a media stream may also be simultaneously presented with the directory listing, such as via a split screen so that the customer's viewing of the media stream is not interrupted during selecting and placing an order. The interactive shopping tool includes means to track the order, secure the transaction, and provide detailed information to the customer.

Still, further exemplary embodiments enable “power” discounting by means of allowing a consumer to initiate a survey to a plurality of media devices associated with other viewers to see if other consumers would agree to buy a good and/or service within a range of discounted pricing, similar to creating a virtual “club” of potential buyers to negotiate a large volume purchase at a discounted price point. The survey results could be transferred from the consumer who initiated the request to one or more vendors who provide the surveyed good or service to see if the vendor(s) would sell a specified quantity at the discounted price point, and if so, then the responding consumers agree to purchase the surveyed good or service at that discounted price point. Similar surveys could be initiated by a vendor who needs to “move” or “unload” goods or products, such as an older model that has been replaced with a newer model. And, the third party communications provider could also initiate the survey to the plurality of consumers.

In other exemplary embodiments, the customer, vendor, and/or communications provider may match customer profile data, near real-time viewership and/or interactive communications data, and/or advertising data to identify one or more advertisements and/or promotional incentives as desirable for distribution during the presentation of the shopping products and/or services in an associated, desirable advertisement time slot (e.g., near real-time slot of an interactive selection of the customer, time slot interval associated with projected maintenance of a purchased consumer good, time slot interval associated with a quantifiable, historical, probabilistic purchase of a favorite take-out order, etc.). According to further exemplary embodiments, billing systems and methods include invoicing, processing, and/or payment of the ordered consumer good or service from the vendor to the customer's communications provider account. For example, if the customer subscribes with a cable television provider and orders take-out food from a vendor, then the customer's bill from the cable television provider may include an invoice for each take-out transaction.

Other embodiments of this invention describe a computer program product. A computer-readable medium stores an Interactive Shopping Module, such as a Dining and Delivery Module for ordering take-out food. The Interactive Shopping Module prompts a user to select vendors and order consumer goods and/or services. For example, the Dining and Delivery Module provides a tool for the customer to access available local take-out dining services and facilitates procurement of selected menu items from a selected vendor. This computer software is easy to use. Further, some of the embodiments include additional presentation capabilities so that a customer can access nutritional information associated with a menu item, access collective nutritional information about a take-out order, and/or track the status of an order, such as whether the order has been prepared, is in transit, location information, and/or historical information about the take-out order (e.g., billing information, contents of take-out order, delivery address, a rating associated with the take-out order, etc.).

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

These and other features, aspects, and advantages of the embodiments of the present invention are better understood when the following Description is read with reference to the accompanying drawings, wherein:

FIG. 1 is a schematic illustrating an exemplary operating environment according to some of the embodiments;

FIG. 2 is another schematic illustrating yet another exemplary operating environment according to some of the embodiments;

FIG. 3 illustrates a block diagram of an operating system according to exemplary embodiments;

FIG. 4 is another schematic illustrating an exemplary operating environment with various communications networks according to some of the embodiments;

FIG. 5 illustrates an exemplary graphical display of an exemplary media device according to some of the embodiments;

FIGS. 6-13 illustrate exemplary graphical user interfaces of an interactive shopping module displayed on the exemplary media device of FIG. 5 according to some of the embodiments;

FIG. 14-15 illustrates exemplary graphical user interfaces of an interactive shopping module displayed on alternative media devices according to some of the embodiments; and

FIG. 16 is schematic illustrating another exemplary operating environment for collecting and processing data collected via the interactive shopping module to select and simultaneously present advertisement content with one or more graphical user interfaces of the interactive shopping module according to some of the embodiments.

### DESCRIPTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. For example, functions of the various hardware, software, processes, methods, and/or operating system may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The exemplary embodiments of the near real-time, interactive shopping communications medium and procurement engine providing interactive shopping tools (also referred to herein as “uSurfnShop”, the “interactive shopping module”, and the “interactive shopping tool”) that may include a consumer goods and/or services media channel or other communications medium (e.g., access to a remote interactive shopping engine such as a interactive shopping engine stored on a domain of a world wide web or alternatively stored on a private network), a shopping services module for user-interaction via a display device or an interactive voice recognition device associated with a customer's media device, customer profile data including authorization and instructions for access of another user to the customer's profile data (e.g., allowing a friend to view historical orders, pricing, delivery times, etc. so that the friend can make an informed decision about placing a contemplated order), advertising data, desirable customer characteristics and metrics, detailed vendor and menu data such as hours of operation, delivery times, historical customer satisfaction data, pricing data, food ingredient(s), allergy warning(s), and nutritional data, graphical images of menu items, and/or menu descriptions, tracking profile data, such as data for locating an physical location of an order and comparing that location with a delivery destination address to determine an expected delivery time, and/or surveying tools and data for establishing a discount price point for selling a selected good or a selected product at a volume discount to a plurality of customers opting to buy the selected good or the selected product within the discounted price point range. Some of the embodiments may include shopping services for take-out food, entertainment, apparel, gifts, and/or household merchandise.

According to an exemplary embodiment, the interactive shopping tool comprises an interactive dining and delivery tool (referred to herein as the “dining and delivery module,” the “dining and delivery tool”, and “Dining & Delivery Engine”) that receives near real-time data from a customer (or an authorized user) regarding the selection of menu items and use of data content to process a take-out order and/or to otherwise provide access and information about the take-out order. The dining and delivery tool includes a food services media channel or other communications medium, customer profile data, advertising data, desirable customer characteristics and metrics, and detailed vendor and menu data such as hours of operation, delivery times, customer satisfaction, pricing, food ingredients, allergy warnings, nutritional data, images of menu items, menu descriptions and other data of the interactive shopping tool. According to some of the embodiments, the interactive dining and delivery tool receives near real-time data from the customer regarding the selection of menu items and use of the data content to process or otherwise provide access and information to process a take-out or delivery food order. For example, in an exemplary embodiment, the dining and delivery tool enables the customer to track his/her food order to find out information related to whether the ordered food is being prepared, whether the food is in transit, such as a location and route of the food being delivered to the customer, and/or historical information about the take-out order (e.g., billing information, contents of take-out order, delivery address, a rating associated with the take-out order, etc.). Further, some of the embodiments include additional presentation capabilities so that the customer can access nutritional information associated with a menu item, access collective nutritional information about a take-out order, and/or filter or provide an alert on menu items that contain ingredients that a customer may need to or want to avoid (e.g., allergic to an ingredient of the menu item that is matched to an ingredient in the customer's profile of allergy data, another medical reason for not eating an ingredient such as a religious reason for not eating an ingredient after matching the menu item ingredients with the customer's profile of ingredients that the customer chooses to not eat on a religious holiday, a personal preference for not eating the ingredient (e.g., vegetarian), etc.). In other exemplary embodiments, the customer, vendor, and/or communications provider may match customer profile data, near real-time customer and/or order data, and/or advertising data to identify one or more advertisements or promotional incentives as desirable for distribution during the presentation of the food services channel (or alternate means for media delivery of the dining and delivery tool) and processes the advertisement or promotional incentive in an associated, desirable advertisement time slot or simultaneously with one or more graphical user interfaces of the dining and delivery tool. According to further exemplary embodiments, billing systems and methods include invoicing, processing, and/or payment of the ordered delivery food from the vendor to the customer's communications provider account. For example, if the customer subscribes with a cable television provider and orders take-out food from the vendor, then the customer's bill from the cable television provider includes the invoice for each take-out transaction (and for other transactions of the interactive shopping module so there is one bill to the customer).

The exemplary embodiments of the interactive shopping tool enhance providing a communications medium of available consumer goods and/or services, such as, for example, dining and delivery services, menu descriptions, and procurement tools associated with the selection, pricing, and distribution for any dining vendor. According to an exemplary embodiment, the dining and delivery services are distributed over a communications medium to a customer's media device, such as, for example a set-top box. The information or content of the dining and delivery services may be distributed by any content distribution system, including, for example, conventional cable television networks, wireless cable television networks, home satellite television networks, internet-based video stream delivery systems, hard disk download systems (in which a program is downloaded and viewed from a local hard disk for a limited amount of time—e.g., TiVo.™. interactive television systems, etc.), “dumb terminal” systems (in which a head end possesses the intelligence and a device, such as a set-top box, passes key stroke information to the head end), and other content distribution systems that allow duplex communication (perhaps with the return path via a separate telephony network) to a set-top box coupled to a viewer's display device, such as a television. As used herein, the terms “media content” (also referred to herein as a “program”), “dining content” (also referred to herein as “dining vendor data”), “customer profile data”, “business data”, “viewer data”, and “advertising/incentive content” include any electronic information, such as, for example video, text, audio, and/or voice in a variety of formats, such as dual tone multi-frequency, digital, analog, and/or others. Additionally, these terms may include: (1) executable programs, such as a software application, (2) an address, location, and/or other identifier of the storage location for the media content, advertisement, or integrated content, and (3) integrated or otherwise combined electronic files, such as a grouping of media, vendor content, menu content, nutritional content, advertisement content, billing programs, and/or others.

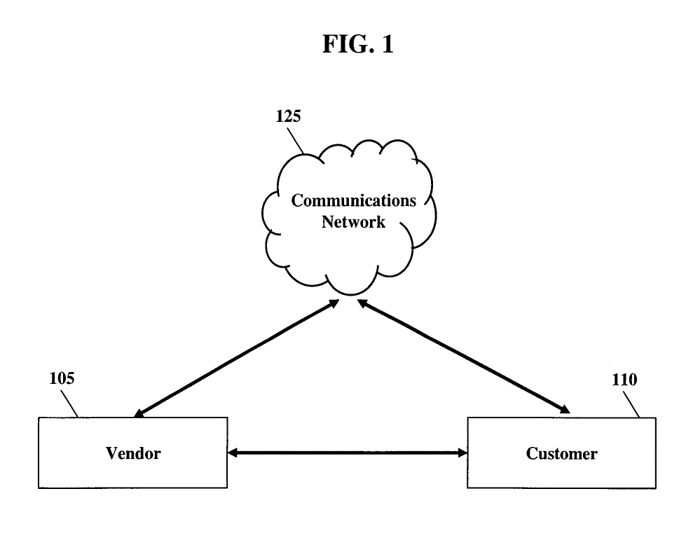

FIG. 1 is a schematic illustrating an exemplary operating environment 100 that includes a vendor's communications device 105, a customer's communications device 110, and a communications network 125. The vendor's communications device 105 includes communications paths to the customer's communications device 110 and the communications network 125. The customer's communications device 110 includes communications paths to the vendor's communications device 105 and the communications network 125. And, the communications network 125 includes communications paths to the customer's communications device 110 and the vendor's communications device 105.

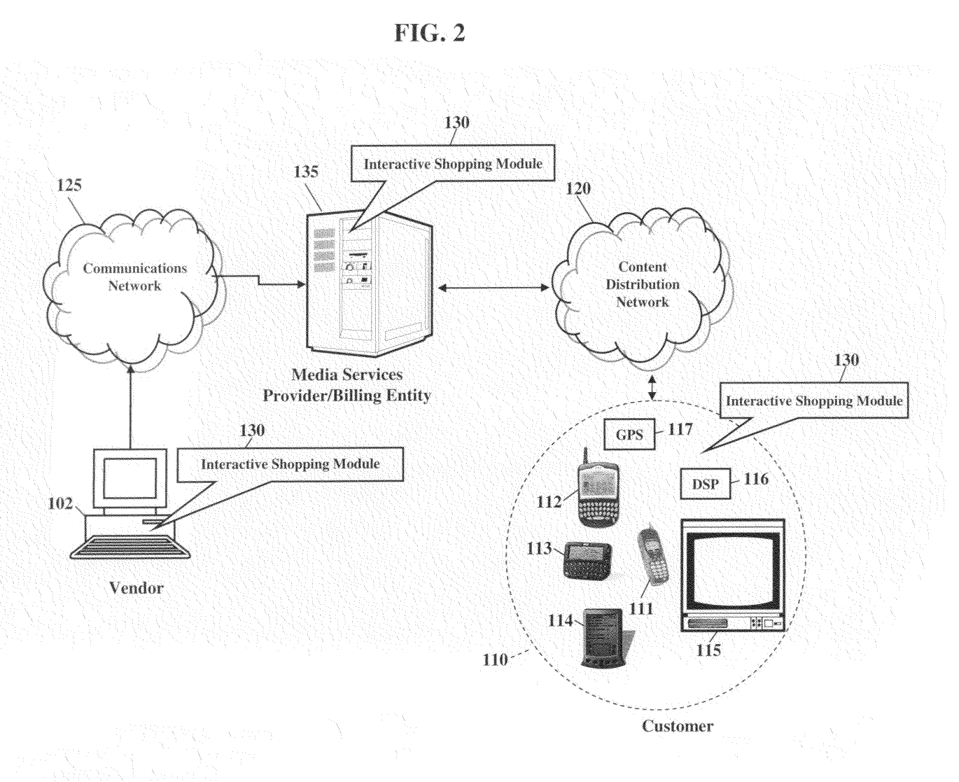

According to an exemplary operating environment 200 of FIG. 2. The customer's communications device 110 includes an interactive shopping tool 130 (also referred to herein as the “Interactive Shopping Module”) to access, update, load, or otherwise manage data associated with consumer goods and/or products, such as, for example, menu, pricing, and delivery information, to a content services provider in communication with the customer's communications device 110. The Interactive Shopping Module 130 comprises methods, systems, computer programs, and/or computer program products. The Interactive Shopping Module 130 may operate within a vendor's computer system 102 or with alternate vendor communications devices as described below.

The Interactive Shopping Module 130 may operate locally and/or remotely. FIG. 2 illustrates the Interactive Shopping Module 130 locally stored/maintained within the computer system 102 that includes a keyboard, mouse, or other input device (e.g., a connected peripheral communications device) for accessing, inputting, and/or otherwise managing data of the Interactive Shopping Module 130. As FIG. 2 also shows, however, the Interactive Shopping Module 130 may also reside within another computer system, such as a computer server 135. The computer system 102 and the computer server 135 may communicate with each other via a communications network 125, such as the Internet (sometimes alternatively known as the “world wide web), an intranet, a local-area network (LAN), a virtual private network (VPN), and/or a wide-area network (WAN). As those of ordinary skill in the art understand, the Interactive Shopping Module 130 may be locally and/or remotely accessed by any computer system communicating with the communications network 125.

According to exemplary embodiments, the Interactive Shopping Module 130 presents consumer goods, services, and/or other associated content or data (also referred to as “media content”). A distributed content network 120 delivers the media content (and other content) to the customer's communications device 110 for presentation of the media content, such as, for example, presentation of a regional (e.g., New York City) Dining and Delivery television channel (or other communications medium) for presentation to the customer's communications device 110. The customer's communications device 110 (and the vendor's communications device of reference numeral 105 of FIG. 1) may be any media presentation device, such as a cellular phone 111, a Voice over Internet Protocol (VOIP) phone 112, an interactive pager 113, a personal digital assistant (PDA) 114, a television 115, and any communications device having a digital signal processor (DSP) 116. The communications device 110 may also include any computer, peripheral device, camera, modem, storage device, telephone, mobile phone, analog/digital recorder, CD/DVD player/recorder, audio equipment, receiver, tuner, and/or any other consumer multicommunications device. The distributed content network 120 may be a television/cable network operating in the radio-frequency domain and/or the Internet Protocol (IP) domain. The distributed content network 120, however, may also include a distributed computing or communications network, such as the Internet, an intranet, a satellite network, a telecommunications network (e.g., Public Switched Telephone Network, Mobile Switching Telephone Office, and others), a local-area network (LAN), virtual private network (VPN), and/or a wide-area network (WAN). The distributed content network 120 may include coaxial cables, copper wires, fiber optic lines, and/or hybrid-coaxial lines. The distributed content network 120 may even include wireless portions utilizing any portion of the electromagnetic spectrum and any signaling standard (such as the I.E.E.E. 802 family of standards). The communications address of the head end (or alternate delivery source of the program) may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver).

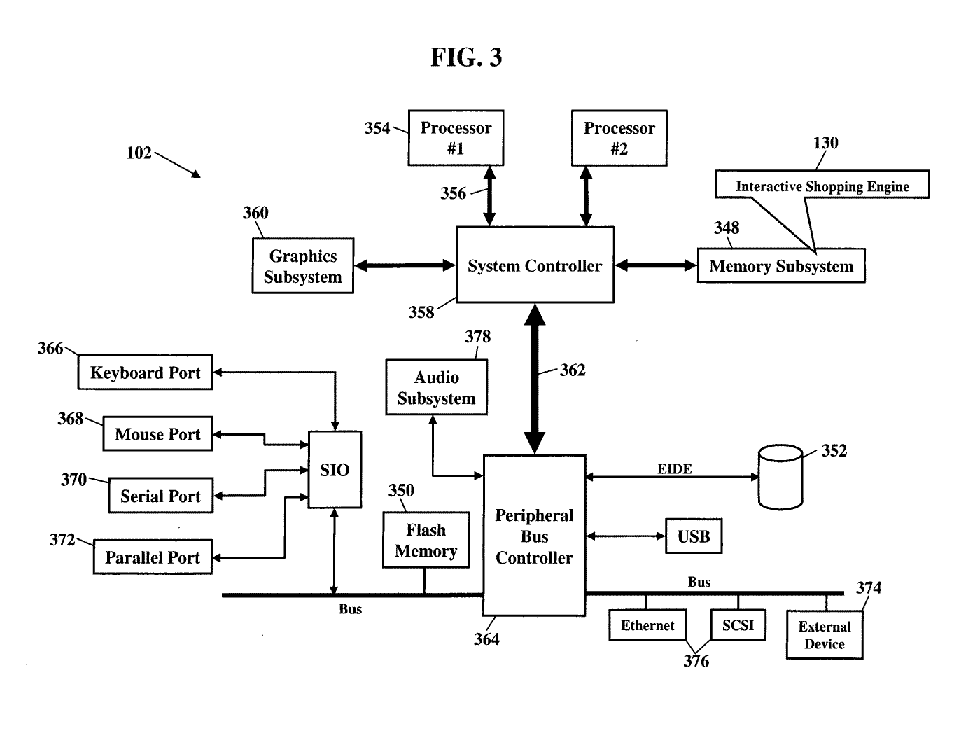

FIG. 3 illustrates block diagram showing the Interactive Shopping Module 130 residing in the computer system 102. However the Interactive Shopping Module 130 may be any computing system or communications device, such as the computer server 135 of FIG. 1 or the customer's communications devices 111, 112, 113, 114, 115, 116, and 117 of FIG. 2. As FIG. 3 illustrates, the Interactive Shopping Module 130 operates within a system memory device. The Interactive Shopping Module 130, for example, is shown residing in a memory subsystem 348. The Interactive Shopping Module 130, however, could also reside in flash memory 350 or a peripheral storage device 352. The computer system 102 also has one or more central processors 354 executing an operating system. The operating system, as is well known, has a set of instructions that control the internal functions of the computer system 102. A system bus 356 communicates signals, such as data signals, control signals, and address signals, between the central processor 354 and a system controller 358 (typically called a “Northbridge”). The system controller 358 provides a bridging function between the one or more central processors 354, a graphics subsystem 360, the memory subsystem 348, and a PCI (Peripheral Controller Interface) bus 362. The PCI bus 362 is controlled by a Peripheral Bus Controller 364. The Peripheral Bus Controller 364 (typically called a “Southbridge”) is an integrated circuit that serves as an input/output hub for various peripheral ports. These peripheral ports are shown including a keyboard port 366, a mouse port 368, a serial port 370 and/or a parallel port 372 for a video display unit, one or more external device ports 374, and networking ports 376 (such as SCSI or Ethernet). The Peripheral Bus Controller 364 also includes an audio subsystem 378. Those of ordinary skill in the art understand that the programs, processes, methods, and systems described in this patent are not limited to any particular computer system or computer hardware. Other architectures are possible, and the Interactive Shopping Module 130 can operate in any architecture.

Those of ordinary skill in the art also understand the central processor 354 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), Sun Microsystems, Inc. (4150 Network Circle, Santa Clara Calif. 95054, www.sun.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

An exemplary operating system is DOS-based. That is, the exemplary operating system may be a WINDOWS-based operating system (WINDOWS® is a registered trademark of Microsoft Corporation, One Microsoft Way, Redmond Wash. 98052-6399, 425.882.8080, www.Microsoft.com). Any other operating system, however, is suitable with this invention. Some suitable operating systems include the UNIX® operating system (UNIX® is a registered trademark of the Open Source Group, www.opensource.org) and a LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Still more suitable operating systems include the Mac® OS (Mac® is a registered trademark of Apple Computer, Inc., 1 Infinite Loop, Cupertino, Calif. 95014, 408.996.1010, www.apple.com). Those of ordinary skill in the art again understand that the programs, processes, methods, and systems described in this patent are not limited to any particular operating system.

The system memory device (shown as memory subsystem 348, flash memory 350, or peripheral storage device 352) may also contain an application program. The application program cooperates with the operating system and with a video display unit (via the serial port 370 and/or the parallel port 372) to provide a Graphical User Interface (GUI). The Graphical User Interface typically includes a combination of signals communicated along the keyboard port 366 and the mouse port 368. The Graphical User Interface provides a convenient visual and/or audible interface with a user of the computer system 102.

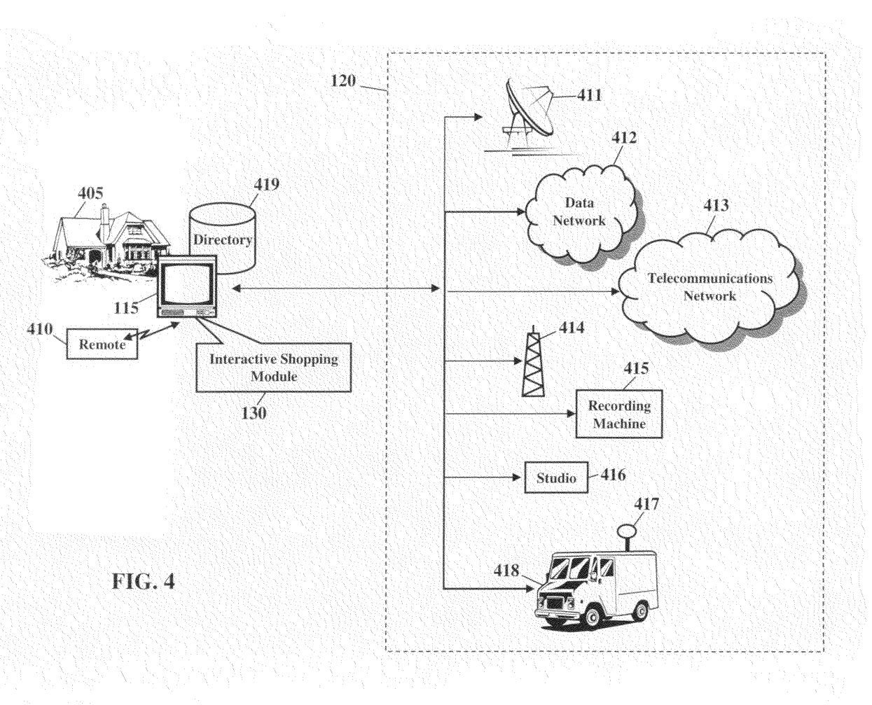

FIG. 4 depicts an exemplary embodiment of an interactive shopping operating environment 400. The interactive shopping operating environment 400 illustrates a residence 405 with a media device 115 shown as an integrated set top box and television having the locally stored interactive shopping module 130 or channel, local database(s) (e.g., directory data) 407, a remote control device 410, and the content distribution network 420. The media device 115 receives graphics, audio and other forms of the interactive shopping module 130 from one or more communications networks that include a variety of broadcasts and communication mediums. As shown in FIG. 4, these broadcast systems may include a direct digital broadcast via satellite TV 411, a communication link with a data communications network 412, a communications link with a telecommunication network 413, a broadcast via digital cable TV 414, and/or a terrestrial broadcast analog and/or digital TV such as a broadcast from a recording device 415, a studio 416, or a mobile vehicle 418 with an antenna and receiver 417. Further, the interactive shopping module 130 may interact with a directory-on-demand service (or an alternate source that provides the directory) via a web browser or alternate interface to present a menu to a display device of the media device. If the interactive shopping module 130 uses the web browser, then an application server may respond to Hyper-Text Transfer Protocol (HTTP) requests by processing the requested URL and parameters according to the services it is providing. This may require accessing and/or storing data in a server database.

As illustrated in FIG. 4, the user typically initiates a shopping session with the media device 115 by interfacing with a graphical user interface of the locally stored interactive shopping tool 130 or an interactive channel by actuating a pushbutton of the remote control device 410, by voice commands, and/or by other selection methods. The graphical user interface(s) enables a broad range of functionality for accessing, modifying, creating, distributing, and/or otherwise managing the dining and delivery services. For example, an infrared remote control, an input terminal, and/or an optional wireless keyboard can communicate with the media device 415 to interact with the graphical user interface that is presented on an audio/visual device such as a TV screen. According to one of the exemplary embodiments, furniture (e.g., a couch, a chair, a table, and other furniture) having an integrated input terminal, control panel, and/or communications interface with the media device 415 is used to select the directory to access, download, store, and/or otherwise manage and to further act as an input/output with the interactive shopping tool 130.

To view the shopping channel and/or the shopping communications directory, the user can use the infrared remote control (or alternate input/output device) to select the channel that he or she wants to access and/or to download by utilizing an electronic communications directory program guide, a search function, entering a channel number, and so on. According to some embodiments, the user may be required to provide an identity and/or a password to access, download, and/or otherwise manage the dining and delivery module. For example, the user may be prompted to enter a personal identifier that may used to distinguish between different members of a household. Accordingly, the ability to distinguish among different users enables each user to secure information. In an alternate embodiment, the media device may be configured to automatically access and/or present the shopping module for a previously initiated session each time the media device is powered on, or alternatively, based upon a viewing preference of a user profile associated with the customer and/or viewer.

In further exemplary embodiments, the media device 115 may simultaneously present other associated broadcast media (or alternate data) during the presentment of the interactive shopping module 130 or channel. Still further, during the presentment of the media content (e.g., consumer goods and services, such as take-out menus of a dining and delivery module), the interactive shopping module 130 may insert instruction signals and/or prompts into the media stream, and, thus allow the user (e.g., a customer, a viewer, etc.) to associate, select, or otherwise respond to the instruction signal.

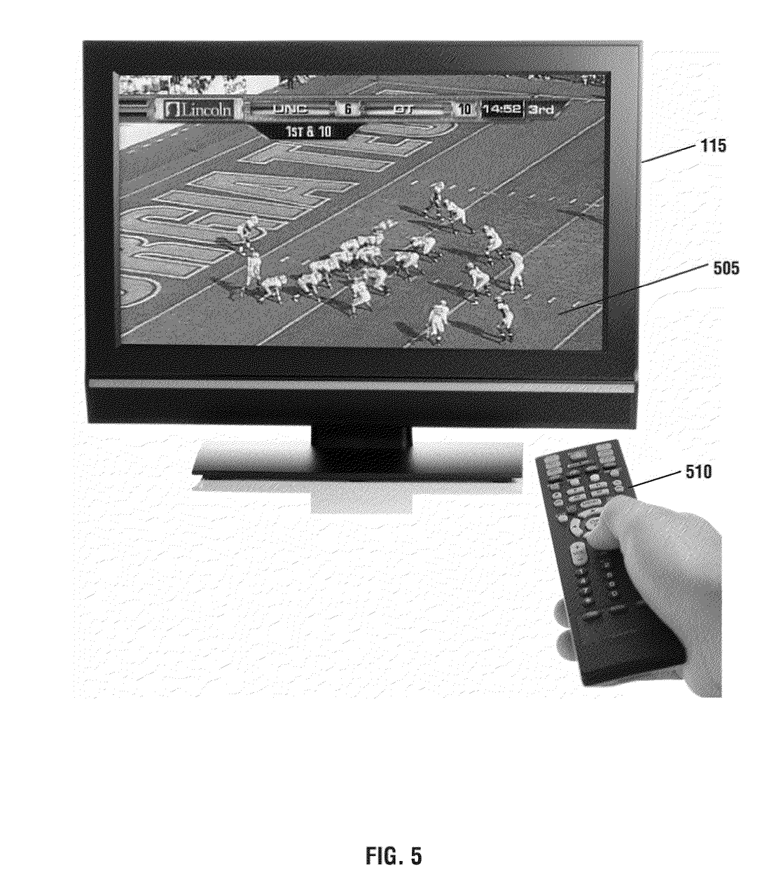

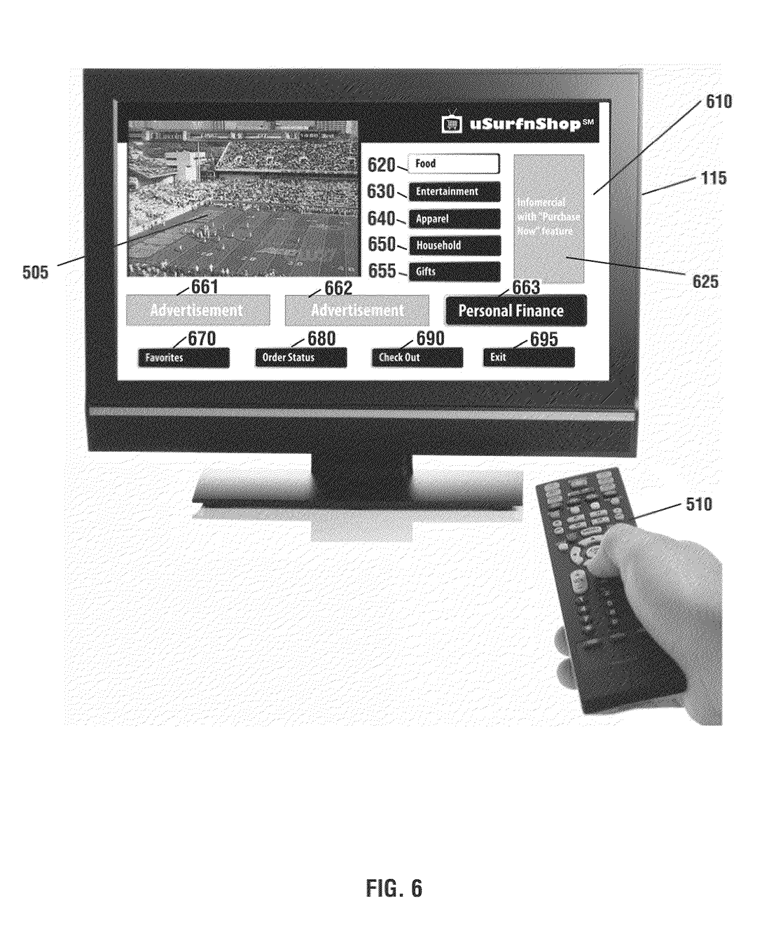

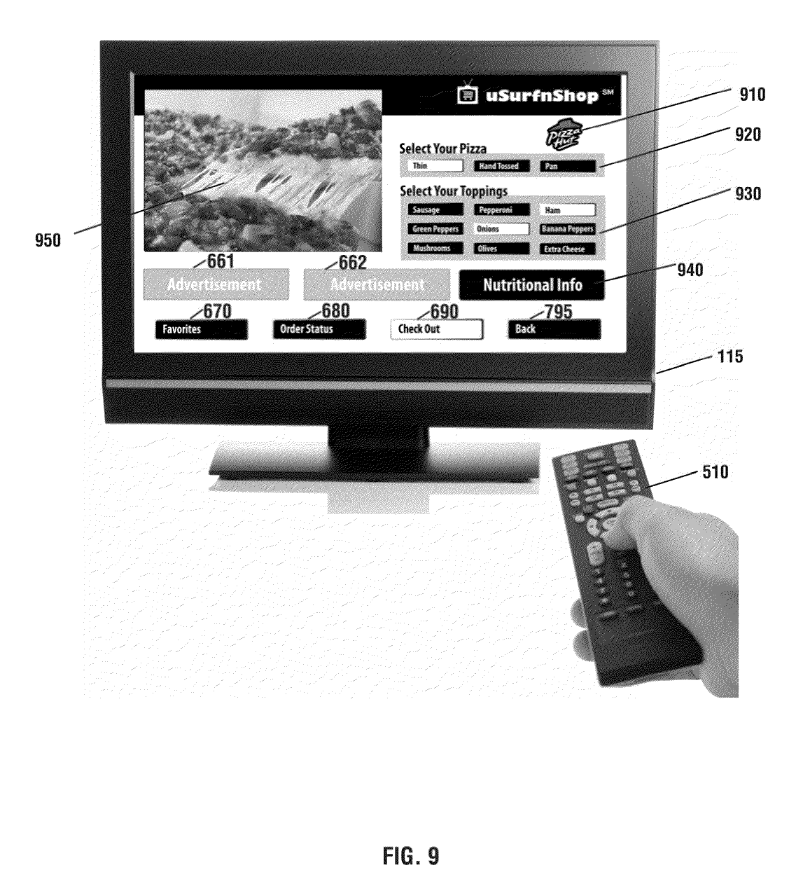

Referring now to FIG. 5, the media device 115 is shown as a television with an integrated set top box having a display area for presenting selected media content 505, such as a media content of a sporting event, media program, infomercial, live broadcast, a news program, a public meeting, and other audio, video, and/or textual media. A remote control 510 is used by a user to interact with and control the media device 115, such as increasing volume, fast forwarding through content or pausing a program, powering on or off the media device and interact with other programs and/or appliances that interface with the media device 115. Using the remote control 510, the user is able to access an exemplary embodiment of the interactive shopping tool 610 (also referred to in FIGS. 6-15 as “uSurfnShop”) and is provided a display that includes the selected media content 505 and features or components of the interactive shopping tool 610. For example, the interactive shopping tool 610 includes categories of providers of various goods and services, such as food category providers 620, entertainment category providers 630, apparel category providers, household category providers 650, gifts category providers 655, and personal finance category providers 663. In addition, the interactive shopping module 610 may include an infomercial with a “buy it now” feature 625 that is simultaneously presented while the user “surfs” the shopping features of the interactive shopping tool 610. And, other advertisements 661 and 662 may be simultaneously presented to the display. According to some of the embodiments of the interactive shopping tool 610, the display may be populated with functional features, such as a favorites category 670 that includes historical preferences of preferred vendors, preferred goods, preferred services, preferred content, preferred connections with other users for authorized access to another user profile to place an order similar to the other user, and other preferences of the user. According to an exemplary embodiment, one of the “favorite” features is to display a preferred order of preselected products from a preferred vendor and automatically order these products using a preferred billing or payment profile of the user. Additional functions may include an order status feature 680 for a status of the order, a check out feature 690 to complete an order, and an exit feature 695 for quitting the interactive shopping module 610.

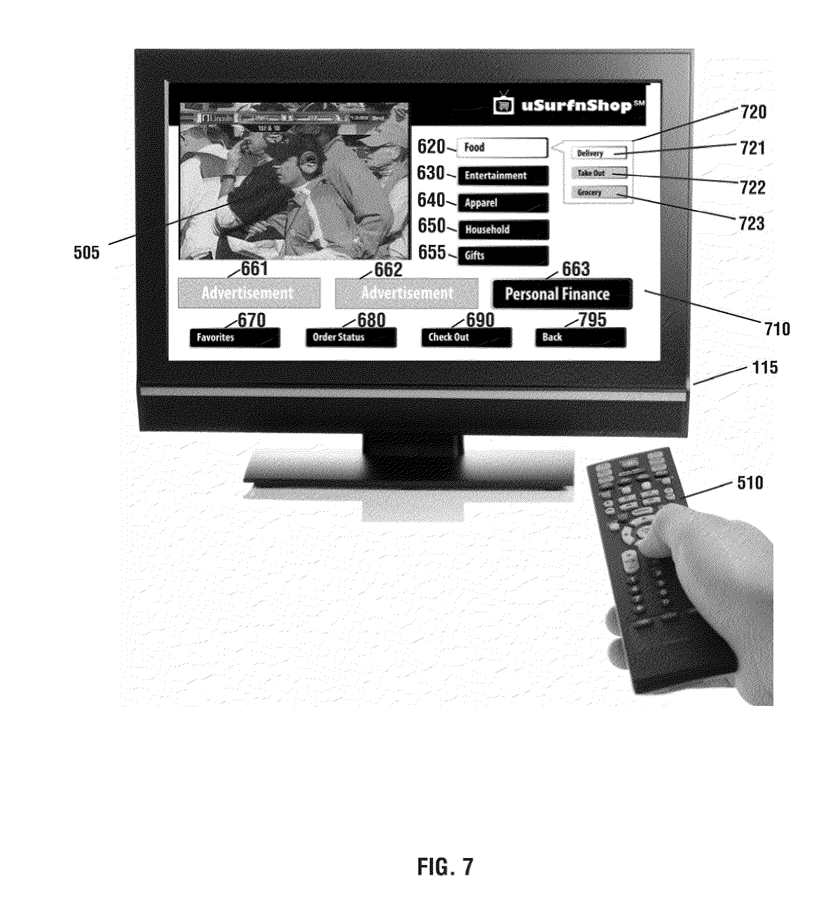

According to FIG. 7, the user may actuate a push button of the remote control device 510 to select the food category providers 620 to further select whether the user would like to access tools 730 for placing a delivery order 721, a take out order 722 (e.g., picking up food at restaurant by user), and/or a grocery order 723. In addition, the interactive shopping tool 610 provides a “back” button 795 that may be selected to exit the additional access tools 730 of the food category providers 620 and return to the previous display screen of FIG. 6.

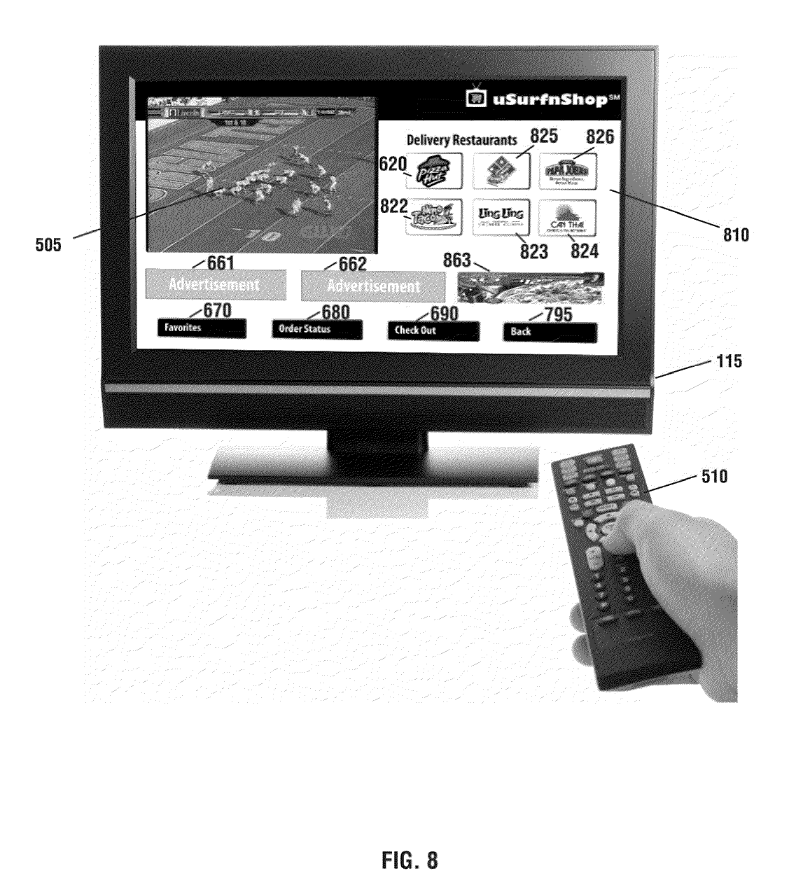

If the user activates the delivery order 721 feature, then a dining and delivery tool 810 as illustrated in FIG. 8 is presented to the display so that the user can select one of the food category providers and access a food menu of each provider. The dining and delivery tool 810 identifies each of the food category providers 821-826 by brand or business name and may further include a coupon or special feature 863 from one of the participating food category providers (e.g., 20% off any order placed with the dining and delivery tool 810).

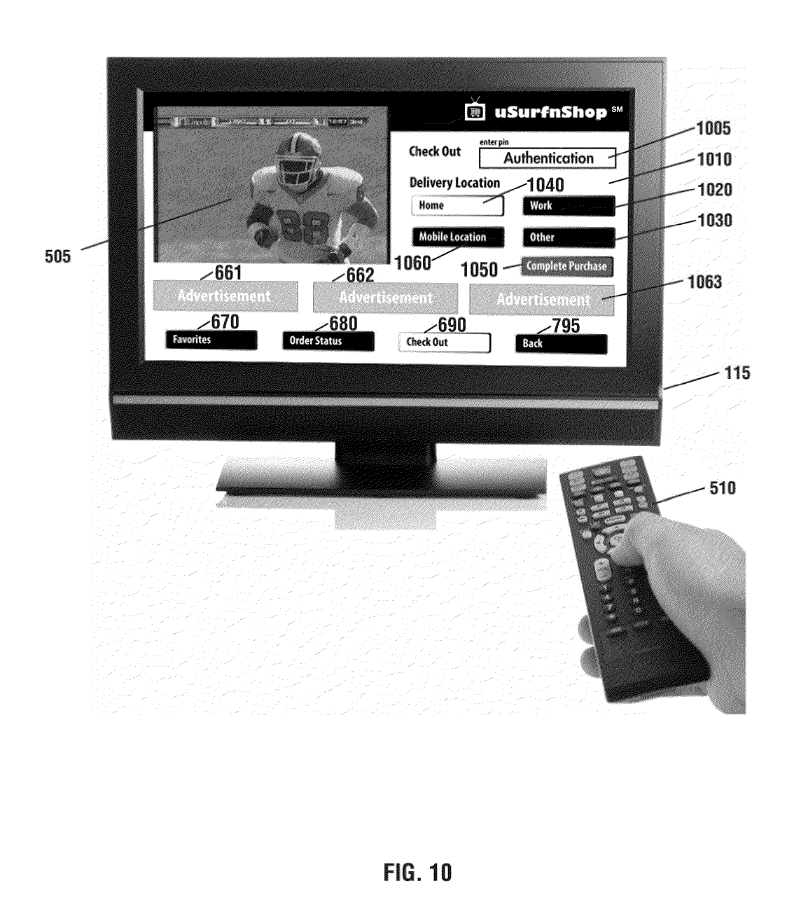

After the user selects one of the food category providers, a detailed display 910 of products, goods and/or services 920, 930 of the selected vendor are presented to the display. In addition, the media device may interrupt the selected content 505 of FIGS. 5-8 and supplant media content 950 of the selected vendor to further illustrate a product, good, and/or service or to further illustrate the order being contemplated by the user. In addition, the user may access a nutritional information feature 940 to access and find out nutritional information of the food order, such as ingredients, fat grams, calories, vitamins, re-heating or storage instructions (e.g., keep refrigerated), warnings (e.g., “contains peanut products, avoid if user has a peanut allergy”, “do not eat uncooked meats while pregnant”, “do not drink alcohol while pregnant”, “use of medication with this food may cause adverse skin reaction”, etc.). When the user is ready to place the order, the dining and delivery tool 1010 of FIG. 10 is presented so that the user can use a check out and authentication feature 1005 to place the order and select one of several user profile delivery locations, such as a work address 1020, another address (e.g., soccer field, recreation center, etc.), a home address 1040, and a mobile or remote location that may be obtained by tracking the user's media device 1060 (e.g., GPS feature in a cellular phone). In addition, the earlier selected media content 505 returns and the user may use a feature to complete the order 1050 or the check out feature 690 to further process the order.

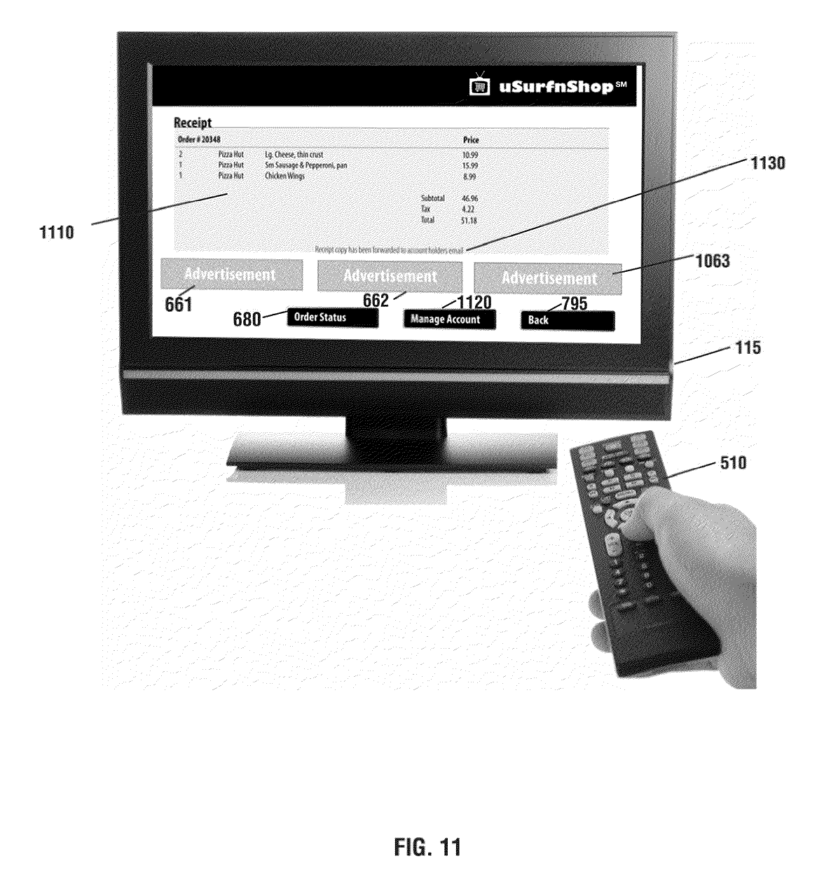

Upon selecting the check out feature 690 to further process the order, the dining and delivery tool may temporarily present a receipt 1110 as shown in FIG. 11 to the display of the media device 115 such that the user can view billing details of the completed order. In addition, a copy of the receipt may be simultaneously communicated to the user's or an alternate account holder's electronic communications address 1130. After the order is completed, the user may access an order status feature 680 to identify if the order has been placed, to track delivery of the order, and/or to estimate near real time delivery forecasts for the arrival of the order based upon a location of order compared to the delivery address. Still further, the user may use a manage account feature 1120 to select the completed order to save as a favorite or to provide billing instructions to the communications provider, such as, to override billing through the communications provider to a credit or debit account of the user or another.

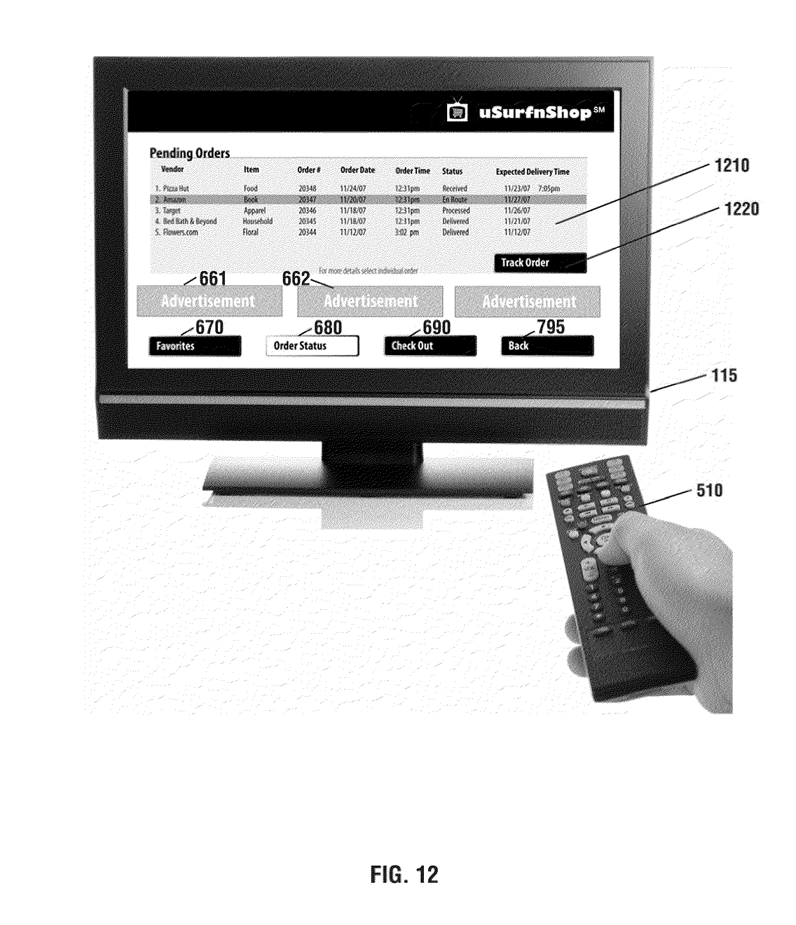

If the user selects the order status feature 680, then the interactive shopping tool may present a history of pending orders 1210 such as a pending pizza delivery order, an outstanding consumer good order, an outstanding merchandise order, an outstanding order with a boutique store, and/or an outstanding order with a florist as shown in FIG. 12. The pending order feature 1210 includes detailed order information including the name of the vendor, description of item(s) purchased, an order number or identifier, an order date, an order time, a status, and/or an expected delivery time. In addition, the user may select additional details by selecting one of outstanding orders. For example, the user could select an outstanding order and add in a comment to add to the history of the order that would be stored in the user's profile of the interactive shopping tool. For example, the user could select the pending pizza order and add in a comment about the manager's name, that the order was taking more than thirty minutes because of a national holiday, that the driver seems to be lost, and other personalized information. Still further, the user could select a track order feature 1220 to obtain detailed tracking information, such as the physical location of an order in transit or delivery to the delivery address, an estimated time of arrival, and/or the delivery route selected by the vendor to reach the delivery address.

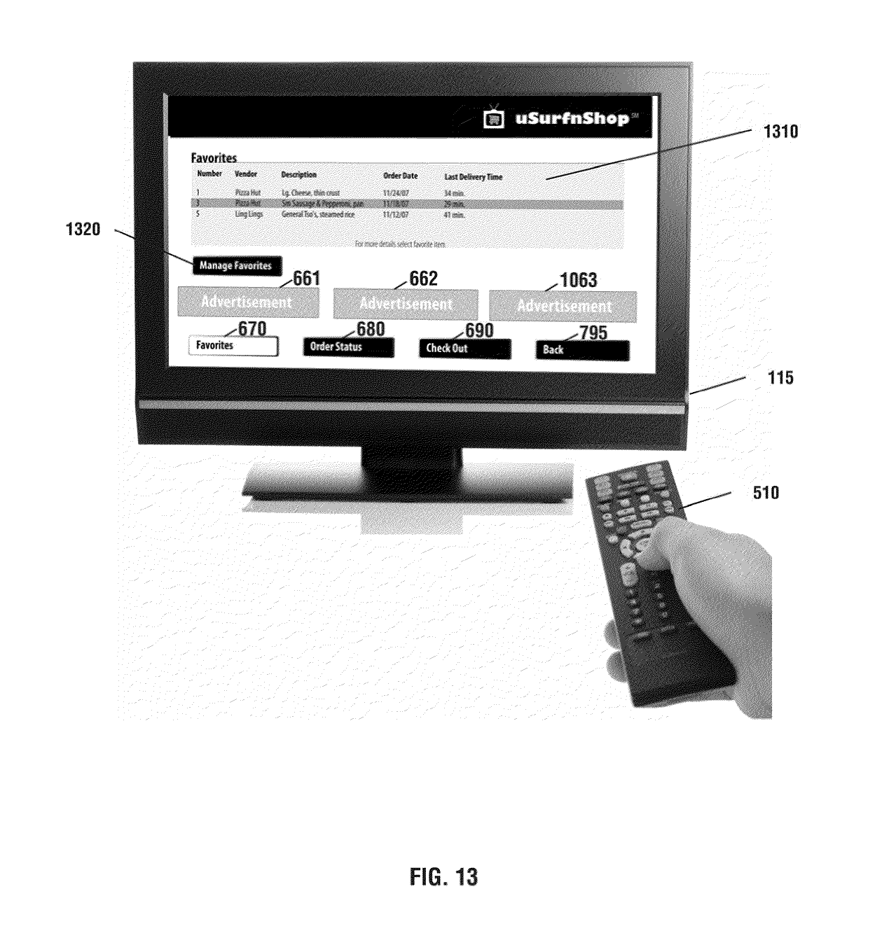

Referring now to FIG. 13, the interactive shopping tool illustrates exemplary favorites 1310 of the user, such as a favorite pizza delivery order, a favorite Chinese delivery order, and other favorites. Still further, the user may select a manage favorites feature 1320 to further define, add to, delete, share (with another user), or otherwise manage the user's favorite historical orders. In addition, the favorites feature may be used by the user to initiate a survey to a plurality of users having a historical order, user profile, or association to query each of the plurality of users about purchasing a selected good or selected service at a discounted price range. For example the user may survey others to see if they agree to purchase a 52″ flat screen brand name television at $500 within the next five (5) days. If the other user selects or otherwise affirmatively responds, then the survey results are acquired and processed to place a bulk or large quantity order with multiple vendors to see if one or more of the multiple vendors agrees to sell the brand name television at a discounted price point—the discounted price point may be different or the same for each of the users affirmatively responding to the survey. Say one user agrees to pay $495, another agrees to $503, and another agrees to $480. Each of these previewed buyers would be $500 or less for the product, that is, one might pay $495, another might pay $500, and still another might pay $480; however, each of them are at or under the discounted price point. Similarly, a third party communications provider or a vendor may use the survey tools to initiate similar queries, such as when a vendor seeks to sell all of a discontinued or older model at a discount price. Further, this survey tool is useful for market analysis to understand trends in consumer buyers, persuasiveness of other consumer buyers, and historical discount pricing offered via the interactive shopping module.

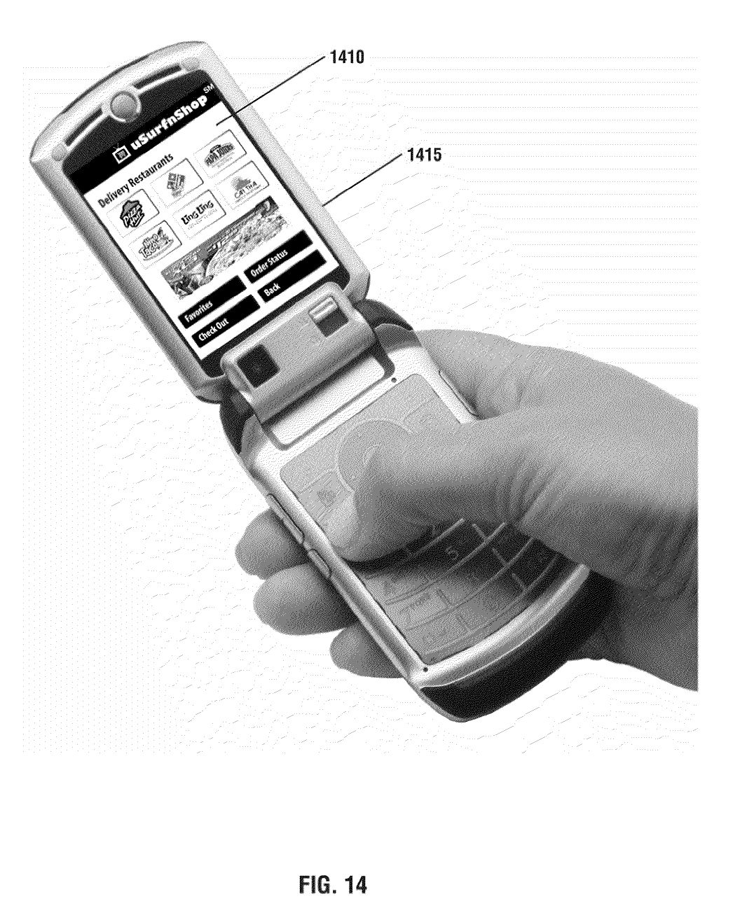

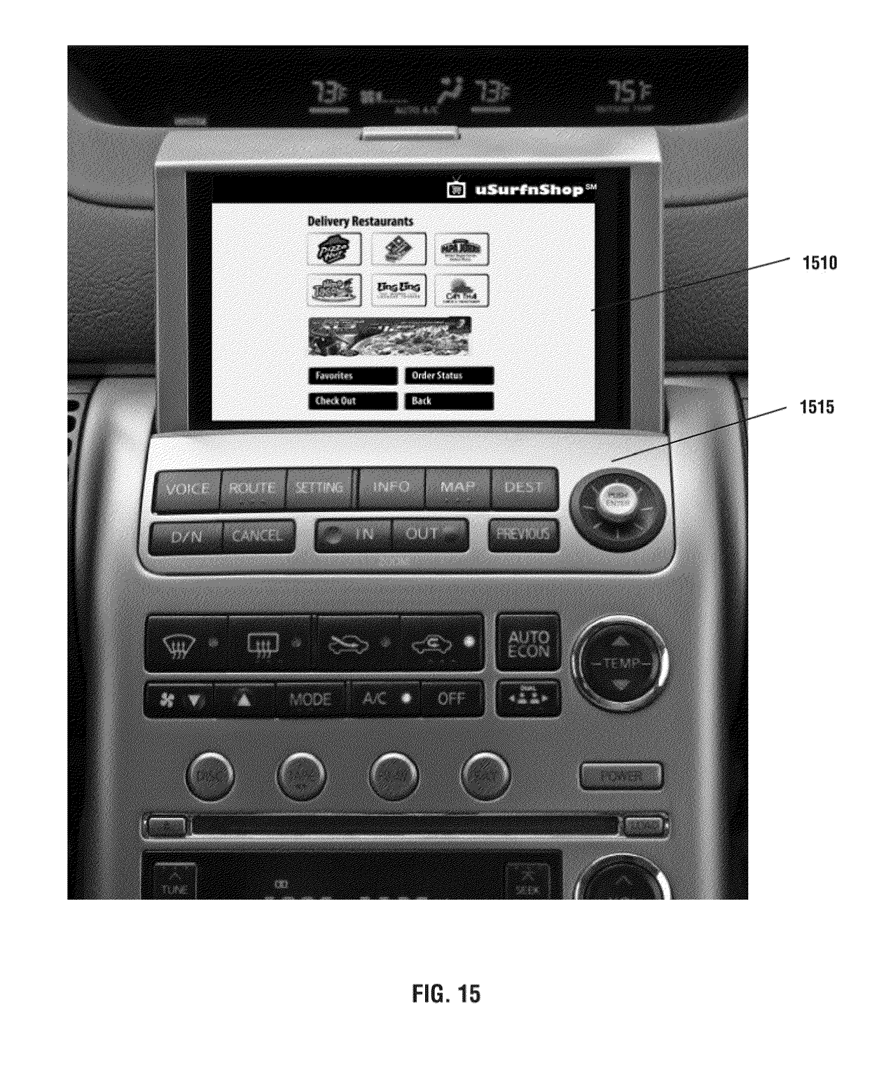

FIGS. 14 and 15 illustrate exemplary embodiments of the dining and delivery tool 1410, 1510 are presented to alternate media devices. FIG. 14 shows the dining and delivery tool 1410 displayed to a remote communications device 1415, such as a cellular or satellite phone, and FIG. 15 shows the dining and delivery tool 1510 displayed to a vehicle media device 1515.

One of the advantages of the interactive shopping tool is the ability to send an order to a third party using a communications address of the third party's media device. For example, if a buyer wanted to send flowers to a third party, the buyer could use the third party's communications address in placing the order and the communications provider, the selected vendor, or program logic integrated into the interactive shopping tool would determine the physical location of the third party for delivery of the order. Exemplary embodiments of the interactive' shopping tool protect the actual delivery address of a third party and keep this information confidential from the buyer.

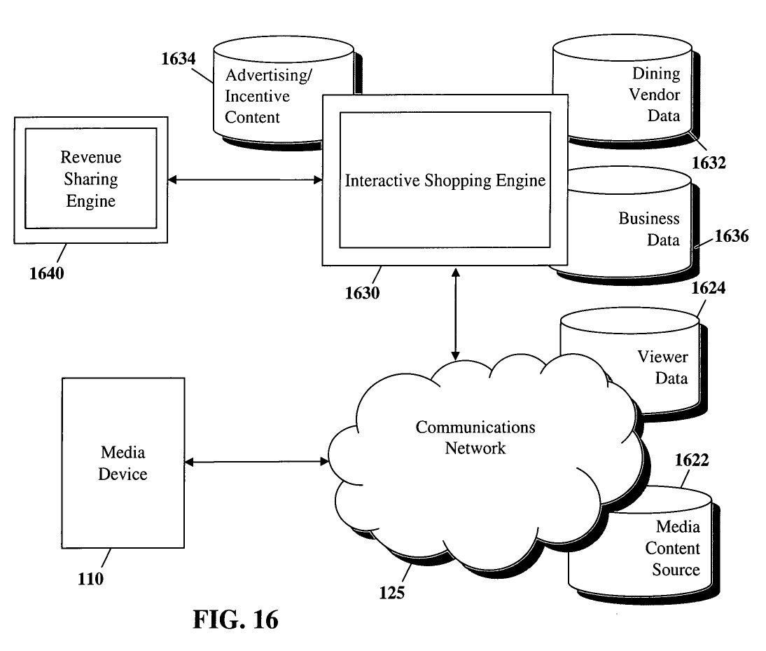

FIG. 16 illustrates another exemplary operating environment including the media device 110 coupled with or otherwise communicating (via the communications network 125) with databases having media content data 1622, viewer data 1624 (information about the user watching selected media content, such as ClickStream data disclosed in U.S. Pat. No. 6,983,478 to Grauch et al. which the Description, Figures, and Claims are included herein), dining and/or vendor data 1632, business data 1636, and advertising/incentive data 1634 that is processed an interactive shopping engine 1630 and a revenue sharing engine 1640 to select and present advertisement content to the media device 110 with the graphical user displays of the interactive shopping tool. According to various embodiments, the viewer data 1624 may be obtained through a number of means, such as the viewer providing the viewer data to his/her communications provider or the viewer can choose to directly provide the viewer data to the interactive shopping engine through a registration process. The vendor enters or otherwise provides dining/vendor data 1632. According to exemplary embodiments, the interactive shopping tool accesses or otherwise retrieves viewership information from the communications network 125 to compare with the dining/vendor 1632 and with the advertising/incentive data 1634 to identify “desirable” advertisements or incentives to present or otherwise target delivery of dining and/or vender content for presentment to the media device.

Some of the advantages of the interactive shopping module or interactive shopping tool include providing a communications channel that allows users to order goods or services, such as food delivery/takeout, using a remote control. Once a delivery address or delivery location has been entered, a consumer selects from participating restaurants or stores by type or by alphabetical listing. After the vendor is selected, the consumer may view and/or listen to a menu. Additional advantages of some of the exemplary embodiments of the interactive shopping module may include:
Revenue to maintain the interactive shopping service may be obtained via subscription from the vendor, from a small consumer fee, banner ads, a percentage of sales or the orders and combinations thereof.
Billing will be selected as either “upon delivery” or will be included on the next bill by the communications provider unless otherwise specified by the user and allows there to be “one” bill. Moreover, a secure billing scenario can be developed.
According to an exemplary embodiment, an interactive shopping interface enables a consumer to place an order via a television-like user interface.
Economies of scale are leveraged to maximize sales of at least one of goods and services, or alternatively, to maximize a discounted price point to the consumer.

The exemplary embodiments of the interactive shopping tool (including the dining and delivery tool) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the interactive shopping tool to be easily disseminated. A computer program product for selecting a structure for an auction includes the interactive shopping tool stored on the computer-readable medium.

The interactive shopping tool (including the dining and delivery tool) may also be physically embodied on or in any addressable (e.g., HTTP, I.E.E.E. 802.11, Wireless Application Protocol (WAP)) wireline or wireless device capable of presenting an IP address. Examples could include a computer, a wireless personal digital assistant (PDA), an Internet Protocol mobile phone, or a wireless pager.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A media device, comprising:
an electronic directory comprising a directory listing of at least one food delivery provider with an interactive menu for accessing, selecting, and placing a food delivery order, the directory listing further associated with at least one of an identification category, a food delivery provider communications address, and a delivery address associated with a location, the location comprising one of a physical address of the media device, a physical address associated with a user, and an address associated with tracking means of the media device; and
a food delivery directory services module for accessing and managing at least one of directory content of the electronic directory for presentation to the media device and of a user profile, the user profile comprising one or more search parameters and a user communications address.

2. The media device of claim 1, wherein the one or more search parameters comprise at least one of historical food delivery order data, billing historical data, food allergy data, nutritional data, and ingredient screening data.

3. The media device of claim 1, wherein the historical food delivery order data comprises at least one of a previously ordered menu item, a price of a previously ordered menu item, a historical delivery time measuring the elapsed time of placing and receiving the food delivery order.

4. The media device of claim 1, wherein the food delivery directory services module is further operable for creating the user profile of the one or more search parameters associated with processing a selection of the at least one food delivery provider and wherein the user profile may be accessed by another authorized third-party user to view historical food delivery order data.

5. The media device of claim 1, further comprising:
a wireless transceiver for transmitting and receiving communications signals to a wireless device.

6. The media device of claim 5, wherein the wireless device comprises at least one of:
a remote control device,
a mobile phone,
a cellular phone,
a WAP phone,
a satellite phone,
a Voice over Internet Protocol phone,
a computer,
a modem,
a pager,
a personal digital assistant,
an interactive television,
a digital signal processor,
a set top box,
an appliance, and
a Global Positioning System device.

7. The media device of claim 6, wherein a media stream is simultaneously presented to the media device and the wireless device.

8. The media device of claim 1, further comprising:
a network connection for transmitting and receiving communications signals between the media device and an external communications network to process the food delivery order.

9. The media device of claim 8, wherein the external communications network comprises a communication services provider, the communications service provider processing the food delivery order with the food delivery provider, and the communications service provider billing the user communications address for the food delivery order.

10. A method, comprising:
receiving an interactive shopping directory, the interactive shopping directory comprising a directory listing of at least one vendor with an interactive menu for accessing, selecting, and placing an order, the directory listing further associated with at least one of an identification category for a good provided by the vendor, an identification category for a service offered by the vendor, a vendor communications address, and a physical address of the vendor;
storing the interactive shopping directory to a media device; and
presenting the interactive shopping directory to the media device.

11. The method of claim 10, further comprising:
receiving a search parameter for searching the interactive shopping directory to select the vendor, the search parameter comprising at least one of geographic coverage of the vendor, the identification category for a good provided by the vendor, the identification category for a service offered by the vendor, availability data, pricing data;
selecting the directory listing having a matched search parameter; and
presenting the directory listing to the media device.

12. The method of claim 11, further comprising:
simultaneously presenting a media stream of the directory listing to a wireless device.

13. The method of claim 11, further comprising:
receiving a request at a time value for the order from the vendor of the selected directory listing;
communicating the request for the order to the vendor via a communications service provider;
storing the order to the media device, the order having a link to the associated directory listing; and
tracking a status of the order from the time value, the status comprising a status that the order has been communicated to the vendor, a status that the order has been filled, a status that the order is in transit to an identified address, a location of the order in transit to the identified address wherein the location identifies a street, nearby cross street, and an estimated delivery time to the identified address, and a status that the order has been delivered.

14. The method of claim 10, further comprising:
authorizing the request for the order such that an unauthorized user is prohibited from communicating the request for the order.

15. The method of claim 10, further comprising:
transmitting a survey initiated by a consumer to a plurality of media devices of at least one other consumer, the survey inquiring about a range of discounted prices that the other consumer would agrees to purchase at a selected discounted price at least one of the good and of the service;
collecting and analyzing a plurality of survey results from a plurality of consumers to determine a discounted price point for at least one of the good and of the service to maximize sales in the range of discounted prices; and
offering the at least one of the good and of the service to the plurality of consumers agreeing to purchase at the discounted price point.

16. The method of claim 13, further comprising:
transmitting a provider survey initiated by the communications service provider to a plurality of media devices, each of the plurality of media devices associated with a unique consumer, the provider survey inquiring about a range of discounted prices that a plurality of consumers would agree to purchase at a selected discounted price at least one of the good and of the service;
collecting and analyzing a plurality of provider survey results to determine a discounted price point for at least one of the good and of the service to maximize sales in the range of discounted prices; and
offering the at least one of the good and of the service to the plurality of consumers agreeing to purchase at the discounted price point.

17. The method of claim 10, further comprising:
transmitting a vendor survey initiated by the vendor to a plurality of media devices, each of the plurality of media devices associated with a unique consumer, the vendor survey inquiring about a range of discounted prices that a plurality of consumers would agree to purchase at a selected discounted price at least one of the good and of the service;
collecting and analyzing a plurality of vendor survey results to determine a discounted price point for at least one of the good and of the service to maximize sales in the range of discounted prices; and
offering the at least one of the good and of the service to the plurality of consumers agreeing to purchase at the discounted price point.

18. A method for awarding an advertisement time slot, comprising:
accessing consumer data about a consumer's order from an interactive shopping directory, the consumer data comprising at least one consumer criterion describing one or more consumers as desirable for receiving advertisement content;
accessing an advertising auction engine to award the advertisement time slot, the advertising auction engine comprising at least one of advertising data, auction data for selecting and bidding on the advertisement time slot, and business data for awarding the advertisement time slot, the advertising auction engine for:
i) matching the consumer data with the auction data and the advertising data to identify one or more advertisements as desirable for distribution to the one or more media devices associated with desirable consumers during the advertisement time slot,
ii) establishing a bid price for each of the identified one or more advertisements, the bid price adjusted by the advertising auction engine based upon the matched data for each advertisement and based upon the business data, and
iii) awarding the advertisement time slot to one of the identified one or more advertisements to maximize a contract price for the advertisement time slot.

19. The method of claim 18, further comprising:
merging the advertisement content of the awarded, identified advertisement with the media content.

20. The method of claim 19, further comprising:
communicating the merged content to at least one media device associated with at least one desirable consumer.
